(19) United States
(12) Patent Application Publication
(10) Pub. No.: US 2021/0234862 A1
(43) Pub. Date: Jul. 29, 2021

(54) DEVICE INTERACTION METHOD, METHOD FOR MANAGING PERMISSION, INTERACTIVE DEVICE AND USER TERMINAL

(71) Applicant: Baidu Online Network Technology (Beijing) Co., Ltd., Beijing (CN)

(72) Inventor: Wenyu WANG, Beijing (CN)

(21) Appl. No.: 17/025,183

(22) Filed: Sep. 18, 2020

(30) Foreign Application Priority Data
Jan. 23, 2020 (CN) 202010076345.0

(51) Int. Cl. H04L 29/06

(52) U.S. Cl. CPC H04L 63/101; H04L 63/0892; H04L 63/102

(57) ABSTRACT

The present disclosure provides a device interaction method, a method for managing a permission, an interactive device, and a user terminal. In the device interaction method, an interactive device may set an interaction permission of a second user terminal through a first user terminal as a management user terminal. When an interaction request of the second user terminal matches its permission setting parameter, the interactive device may respond to the interaction request of the second user terminal to achieve interaction.

### CROSS-REFERENCE TO RELATED APPLICATIONS

This application claims priority to Chinese Patent Application No. 202010076345.0, filed on Jan. 23, 2020, titled “Device interaction method, method for managing permission, interactive device, and user terminal,” which is hereby incorporated by reference in its entirety.

### TECHNICAL FIELD

The present disclosure relates to the field of computer technology, specifically to the field of Internet of Things technology, and more specifically to a device interaction method, a method for managing a permission, an interactive device, and a user terminal.

### BACKGROUND

With the development of the Internet of Things technology, an interactive device may interact with a plurality of user terminals.

In the prior art, as long as bound to an interactive device, a user terminal may interact with the device, and use functionalities of the interactive device. The interaction process between the user terminal and the interactive device does not distinguish permission of the user terminal. For some privacy-related functionalities, if the interaction permission of the user terminal is not distinguished, and the interaction process is likely to cause privacy leakage and cause great inconvenience.

It can be seen that the interaction between the user terminal and the interactive device in the prior art has the problem of easy privacy leakage.

### SUMMARY

Embodiments of the present disclosure provide a device interaction method, a method for managing a permission, an interactive device, and a user terminal, so as to solve the problem of easy privacy leakage in the interaction between the user terminal and the interactive device in the prior art.

In order to solve the above technical problem, the present disclosure is implemented as follows.

In a first aspect, an embodiment of the present disclosure provides a device interaction method, applied to an interactive device, the method including: receiving a permission setting parameter for a second user terminal sent by a first user terminal, the first user terminal being a management user terminal of the interactive device; and responding to an interaction request of the second user terminal, upon receiving the interaction request of the second user terminal, if the interaction request matches the permission setting parameter; where, the first user terminal and the second user terminal are both bound to the interactive device.

Because of using the above technical means, the interactive device may set the interaction permission of the second user terminal through the first user terminal as the management user terminal. When the interaction request of the second user terminal matches its permission setting parameter, the interactive device may respond to the interaction request of the second user terminal to achieve interaction. The management user terminal may set interaction permissions of other user terminals, so that the interactive device may interact with a corresponding user terminal only when the permission matches, improving the privacy of the interaction between the user terminal and the interactive device, and protecting the privacy of the user terminal and the interactive device.

Alternatively, the method further includes:

sending prompt information to the second user terminal, in response to that the interaction request does not match the permission setting parameter.

In this embodiment, the prompt information may be used to inform the second user terminal that the interaction fails, so as to prevent the second user terminal from continuing to send invalid interaction requests.

Alternatively, before receiving the permission setting parameter for the second user terminal sent by the first user terminal, the method further includes: authorizing the first user terminal as the management user terminal, based on a received authorization request sent by the first user terminal.

In this embodiment, the interactive device may receive the authorization request sent by the first user terminal, and authorize the first user terminal as the management user terminal. Then, the interaction permission of the second user terminal may be set by the first user terminal, to manage interactive activities between the second user terminal and the interactive device.

Alternatively, the permission setting parameter comprises whether the second user terminal has a permission to use a target functionality of the interactive device.

In this embodiment, the interaction permissions of different user terminals may be expressed as usage permissions of the different user terminals for different functionalities of the interactive device, so that the interaction between the interactive device and the user terminal is more targeted, and some functionalities of the interactive device that are only applicable to part of the user terminals may not affect other bound user terminals during the interaction. At the same time, it may also ensure that user privacy is not leaked, and further ensure the privacy of the interaction between the user terminal and the interactive device.

In a second aspect, an embodiment of the present disclosure provides a method for managing a permission, applied to a first user terminal, the first user terminal being a management user terminal of an interactive device, and the method including: receiving a permission setting parameter for a second user terminal input by a user; and sending the permission setting parameter to the interactive device, so that the interactive device, upon receiving an interaction request of the second user terminal, determining whether to respond to the interaction request of the second user terminal, based on whether the interaction request matches the permission setting parameter; where, the first user terminal and the second user terminal are both bound to the interactive device.

Because of using the above technical means, the first user terminal as the management user terminal may set the interaction permission of the second user terminal, so that the interactive device may interact with a corresponding user terminal only when the permission matches, improving the privacy of the interaction between the user terminal and the interactive device, and protecting the privacy of the user terminal and the interactive device.

In a third aspect, an embodiment of the present disclosure further provides an interactive device, the interactive device including: a receiving module, configured to receive a permission setting parameter for a second user terminal sent by a first user terminal, the first user terminal being a management user terminal of the interactive device; and a responding module, configured to respond to an interaction request of the second user terminal, upon receiving the interaction request of the second user terminal, if the interaction request matches the permission setting parameter; where, the first user terminal and the second user terminal are both bound to the interactive device.

Alternatively, the interactive device further includes: a prompting module, configured to send prompt information to the second user terminal, in response to that the interaction request does not match the permission setting parameter.

Alternatively, the interactive device further includes: an authorization module, configured to authorize the first user terminal as the management user terminal, based on a received authorization request sent by the first user terminal.

Alternatively, the permission setting parameter comprises whether the second user terminal has a permission to use a target functionality of the interactive device.

In a fourth aspect, an embodiment of the present disclosure provides a user terminal, the user terminal being a management user terminal of an interactive device, and the user terminal including: a receiving module, configured to receive a permission setting parameter for a target user terminal input by a user; and a sending module, configured to send the permission setting parameter to the interactive device, so that the interactive device, upon receiving an interaction request of the target user terminal, determine whether to respond to the interaction request of the target user terminal, based on whether the interaction request matches the permission setting parameter; where, the user terminal and the target user terminal are both bound to the interactive device.

In a fifth aspect, an embodiment of the present disclosure provides an electronic device, including: at least one processor; and a memory, communicatively connected to the at least one processor; where, the memory stores instructions executable by the at least one processor, the instructions, when executed by the at least one processor, cause the at least one processor to perform any method according to the first aspect or the third aspect.

In a sixth aspect, an embodiment of the present disclosure provides a non-transitory computer readable storage medium, storing computer instructions, the computer instructions, being used to cause a computer to perform any method according to the first aspect or the third aspect.

An embodiment in the above disclosure has the following advantages or beneficial effects: the interactive device may set the interaction permission of the second user terminal through the first user terminal as the management user terminal. When the interaction request of the second user terminal matches its permission setting parameter, the interactive device may respond to the interaction request of the second user terminal to achieve interaction. The management user terminal may set interaction permissions of other user terminals, so that the interactive device may interact with a corresponding user terminal only when the permission matches, improving the privacy of the interaction between the user terminal and the interactive device, and protecting the privacy of the user terminal and the interactive device.

The advantages or beneficial effects of the embodiments in the present disclosure will be described below in conjunction with specific embodiments.

### BRIEF DESCRIPTION OF THE DRAWINGS

Accompanying drawings are used to better understand the present solution and do not constitute a limitation to the present disclosure.

FIG. 1 is a schematic flowchart of a device interaction method provided by an embodiment of the present disclosure;

FIG. 2 is a schematic flowchart of another device interaction method provided by an embodiment of the present disclosure;

FIG. 3 is a schematic diagram of an interface of a member list of a first user terminal provided by an embodiment of the present disclosure;

FIG. 4 is a schematic diagram of an interface of a setting interface of a first user terminal provided by an embodiment of the present disclosure;

FIG. 5 is a schematic flowchart of a method for managing a permission provided by an embodiment of the present disclosure;

FIG. 6 is a first schematic structural diagram of an interactive device provided by an embodiment of the present disclosure;

FIG. 7 is a second schematic structural diagram of an interactive device provided by an embodiment of the present disclosure;

FIG. 8 is a third schematic structural diagram of an interactive device provided by an embodiment of the present disclosure;

FIG. 9 is a schematic structural diagram of a user terminal provided by an embodiment of the present disclosure; and

FIG. 10 is a block diagram of an electronic device for implementing embodiments of the present disclosure.

### DETAILED DESCRIPTION OF EMBODIMENTS

The following describes example embodiments of the present disclosure in conjunction with the accompanying drawings, which includes various details of embodiments of the present disclosure to facilitate understanding, and they should be considered merely as examples. Therefore, those of ordinary skill in the art should recognize that various changes and modifications may be made to the embodiments described herein without departing from the scope and spirit of the present disclosure. Also, for clarity and conciseness, descriptions of well-known functionalities and structures are omitted in the following description.

According to an embodiment of the present disclosure, the present disclosure provides a device interaction method.

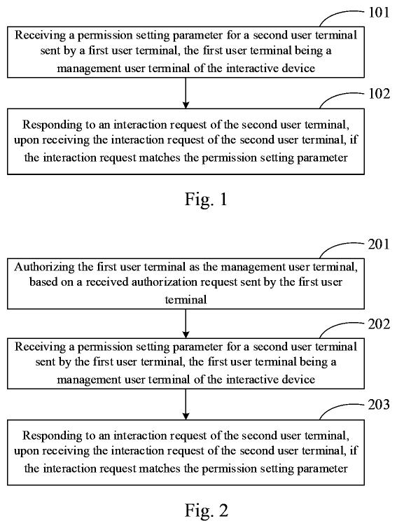

With reference to FIG. 1, FIG. 1 is a flowchart of a device interaction method provided by an embodiment of the present disclosure, and the method is applied to an interactive device.

The interactive device may be a voice interactive device, such as a home voice assistant, a smart speaker, or a visual interactive device, such as a smart screen, a smart TV, or a smart home appliance such as a smart air conditioner, a smart washing machine. In addition to the above interactive devices suitable for home scenarios, it may also be interactive devices suitable for work scenarios such as factories or enterprises, which is not limited herein.

Step 101, receiving a permission setting parameter for a second user terminal sent by a first user terminal, the first user terminal being a management user terminal of the interactive device, where the first user terminal and the second user terminal are both bound to the interactive device.

In an embodiment of the present disclosure, the interactive device may authorize a management account using a specific authorization method, and a user terminal logged in with the management account may be regarded as the first user terminal, that is, the management user terminal of the interactive device. The second user terminal is any user terminal other than the first user terminal and bound to the interactive device, and the second user terminal is a non-management user terminal. The first user terminal may use all the functionalities of the interactive device, and at the same time, the first user terminal may also manage an interaction permission between the second user terminal and the interactive device.

The first user terminal may manage the interaction permission between the second user terminal and the interactive device using the permission setting parameter. Specifically, the first user terminal may determine the permission setting parameter for the second user terminal based on a setting operation performed using the management account, and then send the permission setting parameter to the interactive device and store the permission setting parameter in the cloud. The interactive device may determine a content that may interact with the second user terminal according to the permission setting parameter. At the same time, the first user terminal may also modify the permission setting parameter to change the interaction permission between the second user terminal and the interactive device, which is convenient and quick.

The permission setting parameter for the second user terminal may be expressed as a related interaction permission of the second user terminal for the interactive device. The permission may be whether the second user terminal may use the interactive device, for example, whether the second user terminal B may use the home voice assistant; the permission may also be whether the second user terminal may use the interactive device within a certain period of time, for example, whether the second user terminal C may use the home voice assistant during the time period from 22:00 to 6:00; and the permission may also be whether the second user terminal may use a certain functionality of the interactive device, for example: whether the second user terminal D may use a family album functionality of the home voice assistant. It may be understood that the implementation form of the permission setting parameter is not limited herein, and no limitation is made herein.

Step 102, responding to an interaction request of the second user terminal, upon receiving the interaction request of the second user terminal, if the interaction request matches the permission setting parameter.

Based on the permission setting parameter for the second user terminal sent by the first user terminal, the interactive device may determine the related interaction permission with the second user terminal. When receiving the interaction request sent by the second user terminal, the interactive device may determine whether the interaction request matches the permission setting parameter, and if the current interaction request matches the permission setting parameter sent by the first user terminal for the second user terminal, it may respond to the current interaction request, and the interactive device may interact with the second user terminal.

The interaction request may include a user terminal identifier of the second user terminal, such as an account ID or other identifier information for logging in to the second user terminal; the interaction request may also include requested content, which may include a specific interactive target functionality, for example: open the family album functionality of the home voice assistant; and the interaction request may further include requested time, for example: 22:00, which is not limited herein.

The interaction request matches the permission setting parameter, may be understood as: the second user terminal has the corresponding interaction permission in the interaction request. For example, if the interaction request sent by the second user terminal is to open the family album functionality of the home voice assistant, and in the home voice assistant's permission setting parameter for the second user terminal, the second user terminal may use the family album functionality of the home voice assistant, it is considered that the interaction request matches the permission setting parameter, and the home voice assistant may respond to the interaction request to open the family album functionality for the second user terminal to use.

In an embodiment of the present disclosure, after the interactive device receives the permission setting parameter for the second user terminal, the corresponding relationship between the second user terminal and the permission setting parameter may be stored to a cloud server, and when the interaction request sent by the second user terminal is received, based on the content of the interaction request, the permission setting parameter corresponding to the current second user terminal may be found in the cloud server, to determine whether the interaction request matches the permission setting parameter. If the interaction request matches the permission setting parameter, the cloud returns a confirmation message, and the interactive device may respond to the interaction request to interact with the second user terminal.

The above embodiment of the present disclosure has the following advantages or beneficial effects: the interactive device may set the interaction permission of the second user terminal through the first user terminal as the management user terminal. When the interaction request of the second user terminal matches its permission setting parameter, the interactive device may respond to the interaction request of the second user terminal to achieve interaction. The management user terminal may set interaction permissions of other user terminals, so that the interactive device may interact with a corresponding user terminal only when the permission matches, improving the privacy of the interaction between the user terminal and the interactive device, and protecting the privacy of the user terminal and the interactive device.

With reference to FIG. 2, FIG. 2 is a flowchart of another device interaction method provided by an embodiment of the present disclosure, and the method is applied to an interactive device.

The interactive device may be a voice interactive device, such as a home voice assistant, a smart speaker, or a visual interactive device, such as a smart screen, a smart TV, or a smart home appliance such as a smart air conditioner, a smart washing machine. In addition to the above interactive devices suitable for home scenarios, it may also be interactive devices suitable for work scenarios such as factories or enterprises, which is not limited herein.

Step 201, authorizing the first user terminal as the management user terminal, based on a received authorization request sent by the first user terminal.

The interactive device may receive the authorization request sent by the first user terminal, authorize the first user terminal as the management user terminal, and authorize an account logging in to the first user terminal as a management account. The interactive device may be provided with a specific authorization two-dimensional code. The first user terminal scans the above specific two-dimensional code, and the interactive device may receive an authorization request triggered by scanning the above two-dimensional code; or the interactive device may receive the authorization request sent by the first user terminal using a connection method such as Bluetooth.

After receiving the authorization request from the first user terminal, the interactive device may verify the identity of the first user terminal, and only after the verification is passed can the account currently logged in to the first user terminal be authorized as the management account, and the first user terminal is the management user terminal. Of course, the interactive device may not verify the identity of the first user terminal. If the first user terminal is a user terminal that first sends an authorization request, the first user terminal may be directly determined as the management user terminal, and user terminals that send authorization requests afterwards become non-management user terminals by default, and the interactive device may reject their authorization information, and may return prompt information that the authorization fails.

Step 202, receiving a permission setting parameter for a second user terminal sent by the first user terminal, the first user terminal being a management user terminal of the interactive device, where the first user terminal and the second user terminal are both bound to the interactive device.

For the specific implementation of the present step, reference may be made to the specific description of step 101 in the embodiment shown in FIG. 1. In order to avoid repetition, detailed description thereof will be omitted herein.

Alternatively, the permission setting parameter includes whether the second user terminal has a permission to use a target functionality of the interactive device.

The interactive device usually has a plurality of functionalities. For example, the home voice assistant may have a take a look at home functionality, a family album functionality, a device control functionality, an alarm clock setting functionality, and an audio-visual video functionality. Since user terminals bound to the home voice assistant are not limited to user terminals of family members, for some functionalities that are only applicable to use between the user terminals of the family members, such as the family album functionality, it is necessary to restrict the interaction of other non-family member user terminals.

In an embodiment of the present disclosure, the permission setting parameter includes whether the second user terminal has the permission to use the target functionality of the interactive device. The first user terminal may set interaction permissions of different second user terminals corresponding to different functionalities through the permission setting parameter. After receiving the interaction request of the second user terminal, the interactive device determines whether the second user terminal has the permission to use the target functionality based on the target functionality contained in the interaction request, so as to respond to the interaction request of the second user terminal correspondingly.

The above embodiment of the present disclosure has the following advantages or beneficial effects: the interaction permissions of different user terminals may be expressed as usage permissions of the different user terminals for different functionalities of the interactive device, so that the interaction between the interactive device and the user terminal is more targeted, and some functionalities of the interactive device that are only applicable to part of the user terminals may not affect other bound user terminals during the interaction. At the same time, it may also ensure that user privacy is not leaked, and further ensure the privacy of the interaction between the user terminal and the interactive device.

It should be noted that the technical solution in the present embodiment is also applicable to the embodiment shown in FIG. 1 and can achieve the same beneficial effects.

Step 203, responding to the interaction request of the second user terminal, upon receiving an interaction request of the second user terminal, if the interaction request matches the permission setting parameter.

For the specific implementation of the present step, reference may be made to the specific description of step 102 in the embodiment shown in FIG. 1. In order to avoid repetition, detailed description thereof will be omitted herein.

Alternatively, sending prompt information to the second user terminal, in response to that the interaction request does not match the permission setting parameter.

When receiving the interaction request sent by the second user terminal, based on the content of the interaction request, the interactive device may refer to the cloud server to find the permission setting parameter corresponding to the current second user terminal, and check whether the interaction request matches the permission setting parameter. If the interaction request does not match the permission setting parameter, it means that the second user terminal does not have the corresponding usage permission in the interaction request, and the interactive device cannot respond to the interaction request.

In this regard, the interactive device may send the prompt information to the second user terminal to inform the second user terminal that the interaction fails, and the prompt information may also inform the second user terminal that request information may be sent to the first user terminal to request the related interaction permission for the interactive device. It may be understood that the implementation form of the prompt information is not limited herein, and no limitation is made herein.

The above embodiment of the present disclosure has the following advantages or beneficial effects: the prompt information may be used to inform the second user terminal that the interaction fails, so as to prevent the second user terminal from continuing to send invalid interaction requests.

It should be noted that the technical solution in the present embodiment is also applicable to the embodiment shown in FIG. 1 and can achieve the same beneficial effects.

To facilitate understanding, taking the interactive device being a home voice assistant, and the first user terminal and the second user terminal respectively being user terminals bound to the home voice assistant as an example, an embodiment of the present disclosure will be described in detail.

Assuming that the home voice assistant has three functionalities: the take a look at home functionality, the family album functionality, and the audio-visual functionality, and the user terminals bound to the home voice assistant are respectively: user terminal 1, which corresponds to family member user A; user terminal 2, which corresponds to family member user B, and user B is the wife of user A; user terminal 3, which corresponds to family member user C, and user C is daughter of user A, a 9-year-old teenager; and user terminal 4, which corresponds to user D, and user D is a friend of user A.

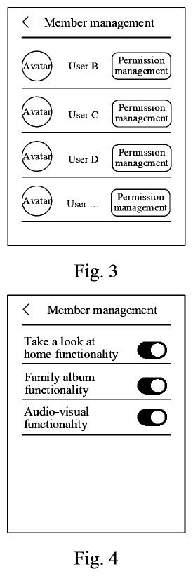

User A may send an authorization request to the home voice assistant through user terminal 1. User terminal 1 may become the management user terminal, and user terminals 2, 3, and 4 become non-management user terminals. The member list shown in FIG. 3 may be displayed in user terminal 1. The member list includes users corresponding to other user terminals bound to the home voice assistant. User A may use user terminal 1 to set interaction permissions for different functionalities for the user terminals corresponding to different users in the member list. Specifically, a control for permission management may be set, such as a control icon of “permission management” as shown in FIG. 3, and then it may jump to an interface as shown in FIG. 4, and user terminal 1 may specifically set the interaction permissions of the user terminals corresponding to different users.

For the family album functionality, as it involves the privacy of the family members, it is only applicable to family member use. User A may set user terminal 4 corresponding to user D to not use this functionality through user terminal 1; for the audio-visual video functionality, it may affect user C's physical and mental health, user A may set user terminal 3 corresponding to user C to not use the audio-visual video functionality through user terminal 1. In an embodiment, it may alternatively set a time period during which user terminal 3 corresponding to user C cannot use the audio-visual video functionality, for example, 22:00 to 6:00. In an embodiment, user terminal 3 corresponding to user C may alternatively be set to not use the home voice assistant; and for the take a look at home functionality, user A may set user terminal 2 corresponding to user B to use the functionality through user terminal 1.

After user A completes the above setting operations, user terminal 1 may organize the above setting operations into permission setting parameters and send them to the home voice assistant through user terminal 1, and the home voice assistant may store the above permission setting parameters to the cloud. When user D sends an interaction request for the family album through user terminal 4 to the home voice assistant, the cloud may first search for the permission setting parameter of user terminal 4, and after determining that user terminal 4 does not have the permission to use the family album, control the interactive device to send prompt information to user terminal 4 to inform that the interaction fails, and at the same time it may also inform that request information may be sent to user terminal 1 to request user terminal 1 to change its permission. When user B sends an interaction request for the take a look at home functionality to the home voice assistant through user terminal 2, the home voice assistant may search for the permission setting parameter of user terminal 2 in the cloud, and determine that user terminal 2 has the permission to use the take a look at home functionality, respond to the interaction request, and open the take a look at home functionality for user terminal 2.

The device interaction method provided by the embodiments of the present disclosure adds many alternative implementation solutions on the basis of the embodiment shown in FIG. 1, which may further improve the convenience of interaction between the user terminal and the interactive device, and improve the user experience.

An embodiment of the present disclosure further provides a method for managing a permission.

With reference to FIG. 5, FIG. 5 is a flowchart of a method for managing a permission provided by an embodiment of the present disclosure, and the method is applied to a first user terminal.

The first user terminal may be a mobile phone, a tablet personal computer, a laptop computer, a personal digital assistant (PDA), a mobile Internet device (MID) or a wearable device and other electronic devices, which is not limited herein.

The method for managing a permission includes the following steps.

Step 501, receiving a permission setting parameter for a second user terminal input by a user.

Step 502, sending the permission setting parameter to the interactive device, so that the interactive device, upon receiving an interaction request of the second user terminal, determining whether to respond to the interaction request of the second user terminal, based on whether the interaction request matches the permission setting parameter.

Here, the first user terminal and the second user terminal are both bound to the interactive device.

For the implementation of the embodiment of the present disclosure, reference may be made to the specific description of the above embodiments. In order to avoid repetition, detailed description thereof will be omitted herein.

The above embodiment of the present disclosure has the following advantages or beneficial effects: the first user terminal as the management user terminal may set the interaction permission of the second user terminal, so that the interactive device may interact with a corresponding user terminal only when the permission matches, improving the privacy of the interaction between the user terminal and the interactive device, and protecting the privacy of the user terminal and the interactive device.

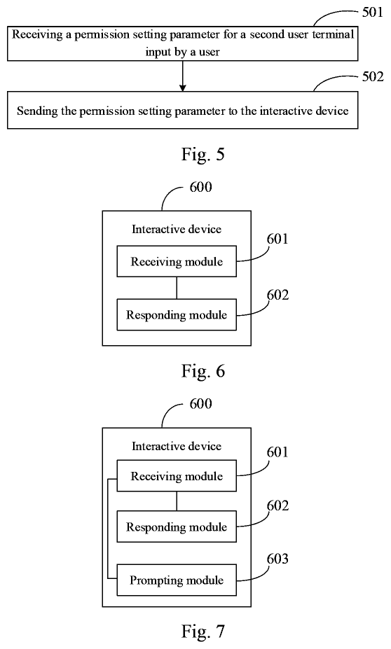

An embodiment of the present disclosure further provides an interactive device. As shown in FIG. 6, the interactive device 600 includes: a receiving module 601, configured to receive a permission setting parameter for a second user terminal sent by a first user terminal, the first user terminal being a management user terminal of the interactive device; and a responding module 602, configured to respond to an interaction request of the second user terminal, upon receiving the interaction request of the second user terminal, if the interaction request matches the permission setting parameter; where, the first user terminal and the second user terminal are both bound to the interactive device.

Alternatively, as shown in FIG. 7, the interactive device 600 further includes: a prompting module 603, configured to send prompt information to the second user terminal, in response to that the interaction request does not match the permission setting parameter.

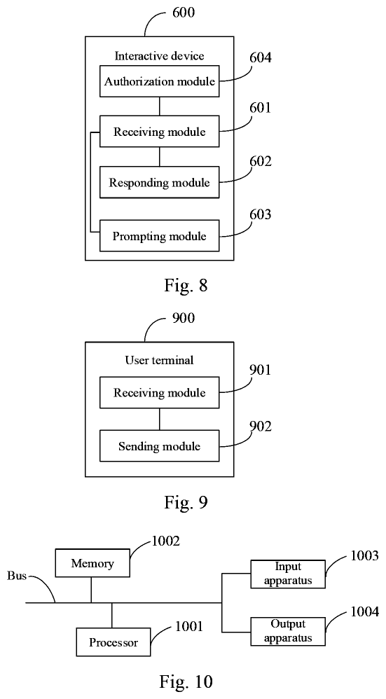

Alternatively, as shown in FIG. 8, the interactive device 600 further includes: an authorization module 604, configured to authorize the first user terminal as the management user terminal, based on a received authorization request sent by the first user terminal.

Alternatively, the permission setting parameter includes whether the second user terminal has a permission to use a target functionality of the interactive device.

In the above embodiment of the present disclosure, the interactive device 600 may implement the processes implemented in the method embodiments of FIG. 1 and FIG. 2 and may achieve the same beneficial effects. To avoid repetition, detailed description thereof will be omitted herein.

An embodiment of the present disclosure further provides a user terminal, as shown in FIG. 9, the user terminal 900 is a management user terminal of an interactive device, and the user terminal 900 includes: a receiving module 901, configured to receive a permission setting parameter for a target user terminal input by a user; and a sending module 902, configured to send the permission setting parameter to the interactive device, so that the interactive device, upon receiving an interaction request of the target user terminal, determine whether to respond to the interaction request of the target user terminal, based on whether the interaction request matches the permission setting parameter; where, the user terminal and the target user terminal are both bound to the interactive device.

In the above embodiment of the present disclosure, the user terminal 900 may implement the processes implemented in the method embodiment shown in FIG. 5 and may achieve the same beneficial effects. To avoid repetition, detailed description thereof will be omitted herein.

As shown in FIG. 10, which is a block diagram of an electronic device according to the device interaction method or the method for managing a permission of the embodiments of the present disclosure. The electronic device is intended to represent various forms of digital computers, such as laptop computers, desktop computers, workbenches, personal digital assistants, servers, blade servers, mainframe computers, and other suitable computers. The electronic device may also represent various forms of mobile apparatuses, such as personal digital processors, cellular phones, smart phones, wearable devices, and other similar computing apparatuses. The components shown herein, their connections and relationships, and their functionalities are merely examples, and are not intended to limit the implementation of the present disclosure described and/or claimed herein.

As shown in FIG. 10, the electronic device includes: one or more processors 1001, a memory 1002, and interfaces for connecting various components, including high-speed interfaces and low-speed interfaces. The various components are connected to each other using different buses, and may be installed on a common motherboard or in other methods as needed. The processor may process instructions executed within the electronic device, including instructions stored in or on the memory to display graphic information of GUI on an external input/output apparatus (such as a display device coupled to the interface). In other embodiments, a plurality of processors and/or a plurality of buses may be used together with a plurality of memories if desired. Similarly, a plurality of electronic devices may be connected, and the devices provide some necessary operations (for example, as a server array, a set of blade servers, or a multi-processor system). In FIG. 10, one processor 1001 is used as an example.

The memory 1002 is a non-transitory computer readable storage medium provided by the present disclosure. The memory stores instructions executable by at least one processor, so that the at least one processor performs the device interaction method or the method for managing a permission provided by the present disclosure. The non-transitory computer readable storage medium of the present disclosure stores computer instructions for causing a computer to perform the device interaction method or the method for managing a permission provided by the present disclosure.

The memory 1002, as a non-transitory computer readable storage medium, may be used to store non-transitory software programs, non-transitory computer executable programs and modules, such as program instructions/modules corresponding to the device interaction method or the method for managing a permission in the embodiments of the present disclosure (for example, the receiving module 601 and the responding module 602 shown in FIG. 6). The processor 1001 executes the non-transitory software programs, instructions, and modules stored in the memory 1002 to execute various functionality applications and data processing of the server, that is, to implement the device interaction method or the method for managing a permission in the foregoing method embodiments.

The memory 1002 may include a storage program area and a storage data area, where the storage program area may store an operating system and at least one functionality required application program; and the storage data area may store data created by the use of the electronic device of the device interaction method or the method for managing a permission, etc. In addition, the memory 1002 may include a high-speed random access memory, and may also include a non-transitory memory, such as at least one magnetic disk storage device, a flash memory device, or other non-transitory solid-state storage devices. In some embodiments, the memory 1002 may optionally include memories remotely provided with respect to the processor 1001, and these remote memories may be connected to the electronic device of the device interaction method or the method for managing a permission through a network. Examples of the above network include but are not limited to the Internet, intranet, local area network, mobile communication network, and combinations thereof.

The electronic device of the device interaction method or the method for managing a permission may further include: an input apparatus 1003 and an output apparatus 1004. The processor 1001, the memory 1002, the input apparatus 1003, and the output apparatus 1004 may be connected through a bus or in other methods. In FIG. 10, connection through a bus is used as an example.

The input apparatus 1003 may receive input digital or character information, and generate key signal inputs related to user settings and functionality control of the electronic device of the device interaction method or the method for managing a permission, such as touch screen, keypad, mouse, trackpad, touchpad, pointing stick, one or more mouse buttons, trackball, joystick and other input apparatuses. The output apparatus 1004 may include a display device, an auxiliary lighting apparatus (for example, LED), a tactile feedback apparatus (for example, a vibration motor), and the like. The display device may include, but is not limited to, a liquid crystal display (LCD), a light emitting diode (LED) display, and a plasma display. In some embodiments, the display device may be a touch screen.

Various embodiments of the systems and technologies described herein may be implemented in digital electronic circuit systems, integrated circuit systems, dedicated ASICs (application specific integrated circuits), computer hardware, firmware, software, and/or combinations thereof. These various embodiments may include: being implemented in one or more computer programs that can be executed and/or interpreted on a programmable system that includes at least one programmable processor. The programmable processor may be a dedicated or general-purpose programmable processor, and may receive data and instructions from a storage system, at least one input apparatus, and at least one output apparatus, and transmit the data and instructions to the storage system, the at least one input apparatus, and the at least one output apparatus.

These computing programs (also referred to as programs, software, software applications, or codes) include machine instructions of the programmable processor and may use high-level processes and/or object-oriented programming languages, and/or assembly/machine languages to implement these computing programs. As used herein, the terms “machine readable medium” and “computer readable medium” refer to any computer program product, device, and/or apparatus (for example, magnetic disk, optical disk, memory, programmable logic apparatus (PLD)) used to provide machine instructions and/or data to the programmable processor, including machine readable medium that receives machine instructions as machine readable signals. The term “machine readable signal” refers to any signal used to provide machine instructions and/or data to the programmable processor.

In order to provide interaction with a user, the systems and technologies described herein may be implemented on a computer, and the computer has: a display apparatus for displaying information to the user (for example, CRT (cathode ray tube) or LCD (liquid crystal display) monitor); and a keyboard and a pointing apparatus (for example, mouse or trackball), and the user may use the keyboard and the pointing apparatus to provide input to the computer. Other types of apparatuses may also be used to provide interaction with the user; for example, feedback provided to the user may be any form of sensory feedback (for example, visual feedback, auditory feedback, or tactile feedback); and any form (including acoustic input, voice input, or tactile input) may be used to receive input from the user.

The systems and technologies described herein may be implemented in a computing system that includes backend components (e.g., as a data server), or a computing system that includes middleware components (e.g., application server), or a computing system that includes frontend components (for example, a user computer having a graphical user interface or a web browser, through which the user may interact with the implementations of the systems and the technologies described herein), or a computing system that includes any combination of such backend components, middleware components, or frontend components. The components of the system may be interconnected by any form or medium of digital data communication (e.g., communication network). Examples of the communication network include: local area network (LAN), wide area network (WAN), and the Internet.

The computer system may include a client and a server. The client and the server are generally far from each other and usually interact through the communication network. The relationship between the client and the server is generated by computer programs that run on the corresponding computer and have a client-server relationship with each other.

According to the technical solution of the embodiments of the present disclosure, the interactive device may set the interaction permission of the second user terminal through the first user terminal as the management user terminal, and when the interaction request of the second user terminal matches its permission setting parameter, the interactive device may respond to the interaction request of the second user terminal to achieve interaction. In this regard, different user terminals have different interaction permissions. For some interactive devices used by user terminals having specific relationships, or interaction functionalities used by user terminals having specific relationships, it is ensured that the interaction process is not affected by other user terminals, so that the interaction is more targeted, and at the same time it may also protect the privacy of the user terminals and the interactive devices.

It should be understood that the various forms of processes shown above may be used to reorder, add, or delete steps. For example, the steps described in the present disclosure may be performed in parallel, sequentially, or in different orders, as long as the desired results of the technical solution disclosed in the present disclosure can be achieved, no limitation is made herein.

The above specific embodiments do not constitute limitation on the protection scope of the present disclosure. Those skilled in the art should understand that various modifications, combinations, sub-combinations and substitutions may be made according to design requirements and other factors. Any modification, equivalent replacement and improvement, etc. made within the spirit and principle of the present disclosure shall be included in the protection scope of the present disclosure.

What is claimed is:

1. A device interaction method, applied to an interactive device, the method comprising:
receiving a permission setting parameter for a second user terminal sent by a first user terminal, the first user terminal being a management user terminal of the interactive device; and
responding to an interaction request of the second user terminal, upon receiving the interaction request of the second user terminal, in response to the interaction request matching the permission setting parameter;
wherein, the first user terminal and the second user terminal are both bound to the interactive device.

2. The method according to claim 1, wherein the method further comprises:
sending prompt information to the second user terminal, in response to that the interaction request does not match the permission setting parameter.

3. The method according to claim 1, wherein, before receiving the permission setting parameter for the second user terminal sent by the first user terminal, the method further comprises:
authorizing the first user terminal as the management user terminal, based on a received authorization request sent by the first user terminal.

4. The method according to claim 1, wherein the permission setting parameter comprises whether the second user terminal has a permission to use a target functionality of the interactive device.

5. A method for managing a permission, applied to a first user terminal, the first user terminal being a management user terminal of an interactive device, the method comprising:
receiving a permission setting parameter for a second user terminal input by a user; and
sending the permission setting parameter to the interactive device, so that the interactive device, upon receiving an interaction request of the second user terminal, determines whether to respond to the interaction request of the second user terminal, based on whether the interaction request matches the permission setting parameter;
wherein, the first user terminal and the second user terminal are both bound to the interactive device.

6. An electronic device, comprising:
at least one processor; and
a memory, communicatively connected to the at least one processor;
wherein the memory stores instructions executable by the at least one processor, the instructions, when executed by the at least one processor, cause the at least one processor to perform operations, the operations comprising:
receiving a permission setting parameter for a second user terminal sent by a first user terminal, the first user terminal being a management user terminal of an interactive device; and
responding to an interaction request of the second user terminal, upon receiving the interaction request of the second user terminal, in response to the interaction request matching the permission setting parameter;
wherein, the first user terminal and the second user terminal are both bound to the interactive device.

7. The electronic device according to claim 6, wherein the operations further comprise:
sending prompt information to the second user terminal, in response to that the interaction request does not match the permission setting parameter.

8. The electronic device according to claim 6, wherein, before receiving the permission setting parameter for the second user terminal sent by the first user terminal, the operations further comprise:
authorizing the first user terminal as the management user terminal, based on a received authorization request sent by the first user terminal.

9. The electronic device according to claim 6, wherein the permission setting parameter comprises whether the second user terminal has a permission to use a target functionality of the interactive device.

10. An electronic device, comprising:
at least one processor; and
a memory, communicatively connected to the at least one processor;
wherein the memory stores instructions executable by the at least one processor, the instructions, when executed by the at least one processor, cause the at least one processor to perform the method according to claim 5.

11. A non-transitory computer readable storage medium storing computer instructions that, when executed by a computer, cause the computer to perform the method according to claim 1.

12. A non-transitory computer readable storage medium, storing computer instructions that, when executed by a computer, cause the computer to perform the method according to claim 5.
